(19) United States
(12) Patent Application Publication
(10) Pub. No.: US 2008/0189767 A1
(43) Pub. Date: Aug. 7, 2008

(54) ACCESSING FILE RESOURCES OUTSIDE A SECURITY BOUNDARY

(75) Inventors: Nikhil Kothari, Sammamish, WA (US); Stefan N. Schackow, Bellevue, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/670,142

(22) Filed: Feb. 1, 2007

(51) Int. Cl. G06F 21/22

(52) U.S. Cl. 726/4

(57) ABSTRACT

The present invention extends to methods, systems, and computer program products for accessing file resources outside a security boundary. The present invention can provide a modules running within a security boundary (e.g., sandboxed client-side scripts) access to a file outside the security boundary without divulging security information related the file. When file access is permitted, a file stream including relevant portions of the file (and potentially only those portions needed) for performing a requested file operation is generated. The module is returned a reference to file stream to give the module access to the relevant portions of the file. File access decisions can be made based on ambient data already accessible to a host environment such that file access decisions can be made in a more automated manner.

### CROSS-REFERENCE TO RELATED APPLICATIONS

Not Applicable.

### BACKGROUND

### Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks are distributed across a number of different computer systems and/or a number of different computing components.

One common form of network based communication is exchanging electronic messages on the Worldwide Web (“WWW”). Content on the Worldwide Web is typically accessed in a client/server model. A “Web browser” of a client computer system sends a request to access content that is provided by a “Web Server” of a server computer system (e.g., by entering a Uniform Resource Locator (“URL”) into the Web browser). If the user of the Web browser is authorized to access the content, the Web server typically provides the content to the Web browser. In a Web environment, content and requests for content, are frequently transported using Hypertext Transfer Protocol (“HTTP”). Web-based content can be provided in HyperText Markup Language (“HTML”) pages, style sheets, images, scripts, etc.

Scripts are executable code that is sent from a Web server to a Web browser. Scripts can be executed at the Web browser to assist in providing requested content. For example, a script may access a current time from the system clock of a client computer system and display the current time intermingled with other received content from the Web server.

However, there is typically limited (if any) notion of pre-established trust between different computer systems on the Internet. Thus, executable code received over the Internet is frequently under suspicion for including malicious functionality, such as, for example, viruses, key loggers, spyware, Trojan horses, etc. Further, there is typically, limited, if any, mechanisms for determining what a portion of executable code will do before it is executed. Accordingly, executable code received over the Internet is typically given only limited access to the resources of the computer system that received the executable code.

Different security mechanisms can be employed to limit the permitted computer system access for specified executable code. One mechanism frequently utilized in Web based environments, is to execute code, such as, for example, a script, within a security boundary (sometimes referred to as a “sandbox”). A limited set of resources is allocated for use within the security boundary such that if a script does include malicious code, execution of the malicious code does not impact resources outside of the security boundary. For example, code running in a sandbox is typically prevented from accessing any files stored external to the sandbox. Thus, a local file system is typically completely inaccessible to executable code received over the Internet when the executable code is run within a sandbox.

Unfortunately, there are also many applications, for example, rich internet applications (“RIAs”) that have legitimate needs for selected access to some portions of a local file system. For example, offline functionality and local caching can require at least some local file system access to work properly. However, even though these types of applications may be of benefit to a user, the user may still choose to sandbox these types of applications (thus, preventing access to a local file system) or just not use them, due to general security concerns related to executable code received over the Internet.

### BRIEF SUMMARY

The present invention extends to methods, systems, and computer program products for accessing file resources outside a security boundary. A network based application (e.g., a Web based script) running inside a security boundary (e.g., a sandbox) of a host environment (e.g., a Web browser) sends a file operation request. The file operation request requests that a file operation (e.g., reading from and/or writing to a file) be implemented at external storage outside of the security boundary. A file access abstraction layer in the host environment receives the file operation request from the network based application running inside the security boundary.

The file access abstraction layer accesses file security policies that control access to the external storage. The file security policies are configured to make a file access decision for the file operation request based on file access information corresponding to the file operation request. The file access abstraction layer accesses file access information associated with the file operation request. The file access information includes at least one property of a setting for the computer system and at least one property of the file operation request.

The file access abstraction layer applies the file security polices to the file access information to make a file access decision (e.g., permitting the request, either with the requested access or reduced access, or denying the request) for the received file operation request. The file access abstraction layer returns the file access decision to the network based application to indicate to the network based application whether or not the network application is permitted to implement the requested file operation outside of the security boundary.

When it is determined that a requested file operation is to be permitted, the file access abstraction layer accesses a file corresponding to the file operation request from the external storage. The file access abstraction layer generates a file stream from the accessed file. The file stream includes relevant portions of the file for performing the requested file operation without divulging other sensitive file related information (e.g., security and file path information). The file access abstraction layer sends the reference to the file stream to the network based application. The reference to the file stream permits the network based application (within the security boundary) to perform the requested file operation on the relevant portions of the file (stored outside the security boundary) without providing the network based application with access to other portions of the file.

The network based application receives the reference to the file stream and uses the reference to access the file stream. The network based application performs the requested file operation on the relevant portions of the file included in the file stream without accessing other portions of the file.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates an example computer architecture that facilitates accessing file resources outside a security boundary.

FIG. 1B illustrates some of the types of policies and information that can be used to make a file access decision.

FIG. 2 illustrates a flow chart of an example method for making a file access decision for a module inside a security boundary

FIGS. 3A and 3B illustrate a flow chart of an example method for permitting a module inside a security boundary to access a file outside the security boundary.

### DETAILED DESCRIPTION

The present invention extends to methods, systems, and computer program products for accessing file resources outside a security boundary. A network based application (e.g., a Web based script) running inside a security boundary (e.g., a sandbox) of a host environment (e.g., a Web browser) sends a file operation request. The file operation request requests that a file operation (e.g., reading from and/or writing to a file) be implemented at external storage outside of the security boundary. A file access abstraction layer in the host environment receives the file operation request from the network based application running inside the security boundary.

The file access abstraction layer accesses file security policies that control access to the external storage. The file security policies are configured to make a file access decision for the file operation request based on file access information corresponding to the file operation request. The file access abstraction layer accesses file access information associated with the file operation request. The file access information includes at least one property of a setting for the computer system and at least one property of the file operation request.

The file access abstraction layer applies the file security polices to the file access information to make a file access decision (e.g., permitting the request, either with the requested access or reduced access, or denying the request) for the received file operation request. The file access abstraction layer returns the file access decision to the network based application to indicate to the network based application whether or not the network application is permitted to implement the requested file operation outside of the security boundary.

When it is determined that a requested file operation is to be permitted, the file access abstraction layer accesses a file corresponding to the file operation request from the external storage. The file access abstraction layer generates a file stream from the accessed file. The file stream includes relevant portions of the file for performing the requested file operation without divulging other sensitive file related information (e.g., security and file path information). The file access abstraction layer sends the reference to the file stream to the network based application. The reference to the file stream permits the network based application (within the security boundary) to perform the requested file operation on the relevant portions of the file (stored outside the security boundary) without providing the network based application with access to other portions of the file.

The network based application receives the reference to the file stream and uses the reference to access the file stream. The network based application performs the requested file operation on the relevant portions of the file included in the file stream without accessing other portions of the file.

Embodiments of the present invention may comprise a special purpose or general-purpose computer including computer hardware, as discussed in greater detail below. Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, computer-readable media can comprise physical (or recordable type) computer-readable storage media, such as, RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

In this description and in the following claims, a “network” is defined as one or more data links that enable the transport of electronic data between computer systems and/or modules. When information is transferred or provided over a network or another communications connection (either hardwired, wireless, or a combination of hardwired or wireless) to a computer, the computer properly views the connection as a computer-readable medium. Thus, by way of example, and not limitation, computer-readable media can also comprise a network or data links which can be used to carry or store desired program code means in the form of computer-executable instructions or data structures and which can be accessed by a general purpose or special purpose computer.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

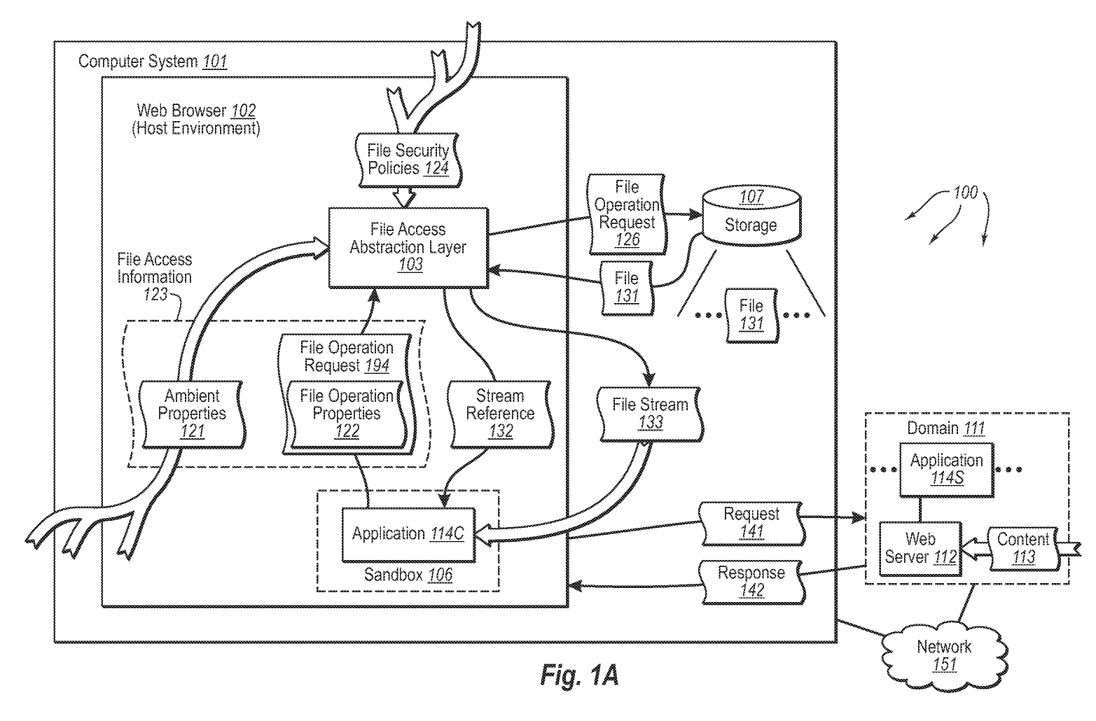

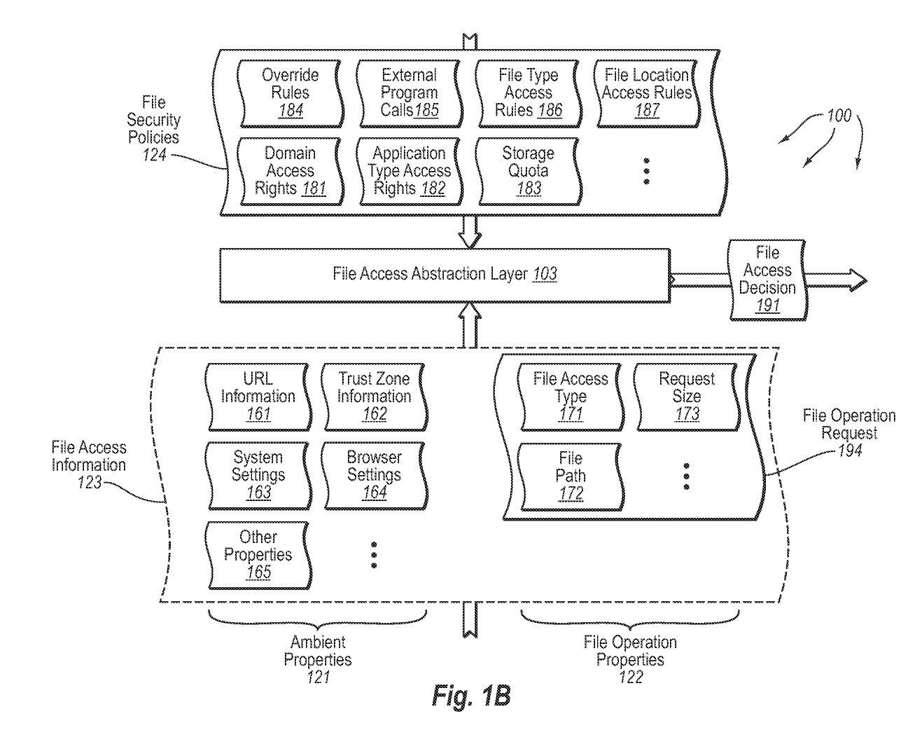

FIG. 1A illustrates an example computer architecture 100 that facilitates accessing file resources outside a security boundary. Computer architecture 100 includes computer system 101, network 151, and domain 111. Depicted in computer architecture 100 are various components including, Web browser 102 (or alternately some other type of host environment), file access abstract layer 103, application 114C, application 114S, and Web server 112. Each of the various components can be connected to network 151, such as, for example, a Local Area Network (“LAN”), a Wide Area Network (“WAN”), or even the Internet. Thus, the various components can receive data from and send data to other components connected to the network. Accordingly, the components can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network. For example, components can exchange HTTP requests and responses and Simple Object Access Protocol (“SOAP”) envelopes containing Web service related data.

In some embodiments, application 114C and application 114S are different portions of a distributed application, such as, for example, a Web services application. However, application 114C can be virtually any type of application and can include virtually any type of executable code. Further, application 114C need not necessarily even be related to application 114S.

Domain 111 can be identified by a domain name, such as, for example, a domain name service (“DNS”) name that is resolvable to an IP address. The domain name can be entered into a Web browser (potentially along with other identifying information for a specified application within the domain 111) to direct a browser to request content from Web server 112. A domain name along with other identifying information can be included in a Uniform Resource Locator (“URL”) entered into a Web browser. Depending on a type of request and/or a received URL, Web server 112 can access content from content 113 and/or initiate a Web-based application, such as, for example, application 114S. Application 114S can request data from other locations in domain 111, such as, for example, from file stores, databases (e.g., a SQL or other relational database), etc. Web server 112 can include content from content 113 and/or other locations in a response to a Web browser request. Web server 112 can also send executable code (e.g., scripts or other computer-executable instructions) to a Web browser in response to a request.

Web browser 102 can be configured to request Web-based content from domains, such as, for example, domain 111, accessible via network 151. Web-based content can include text data, image data, audio/video data, executable code, etc. When executable code is received, for example, a Web-based application, the executable code can be executed within Web browser 102. Web-based applications can request access to file data (e.g., files, directory structures, etc.) accessible (both locally and remotely) to computer system 101.

Thus, for example, it may be that Web browser 102 sends requests 141 (an HTTP get) to domain 111 (by utilizing an appropriate URL for domain 111). Domain 111 can receive request 141 and direct request 141 to Web server 112. Web server 112 can process request 141 and generate/obtain corresponding content. The corresponding content can be returned to Web browser 102 in response 142 (an HTTP message). Response 142 can include application 114C that is to be executed at Web browser 102 to perform other operations and/or obtain further content related to request 141.

Application 114C can be executed within sandbox 106 (or some other security boundary) to mitigate the potential for harmful code included in application 114C (e.g., viruses, Trojan horses, spy ware, etc.) gaining access to resources of computer system 101. Nonetheless, application 114C may request access to (locally and/or remotely stored) file data that is external to sandbox 106, such as, for example, a file stored at storage 107. When application 114C requests access to file data that is external to sandbox 106, the request can be directed to file access abstraction layer 103. When configuring sandbox 106, Web browser 102 can specify that any file requests originating in sandbox 106 are to be directed to file access abstraction layer 103.

Generally, file access abstraction layer 103 is configured to regulate inbound and outbound file based communication to and form applications, such as, for example, application 114C within a security boundary. To facilitate regulation of file based communication, file access abstraction layer 103 can make file access decisions when a module (e.g., application 114C) within a security boundary (e.g., within sandbox 106) attempts to communicate with a storage location outside the security boundary are vice versa.

Accordingly, file access abstraction layer 103 can modify file access requests sent from an application within a security boundary directed to a storage location outside of the security boundary. For example, file access abstraction layer 103 can modify a file access request sent from application 114C and directed to storage 107. Likewise, file access abstraction layer 103 can modify inbound communication sent from a storage location outside of the security boundary to a module with in the security boundary. For example, file access abstraction layer 103 can modify inbound communication sent from storage 107 and directed to application 114C. In some embodiments, modifying inbound communication includes creating a file stream for specified portions of a file such that the other portions of the file are not divulged to an application inside a security boundary.

Access abstraction layer 103 can utilize file security policies and file access information when making a file access decision. Thus, a user or administrator can change file security polices and/or file access information to influence file access decisions.

File security polices can be accessed from within Web browser 102, other locations at computer system 101 (e.g., a system registry or configuration file), and locations external to computer system 101 (e.g., through references to external program calls, etc.). Similarly, file access information can also be accessed from within Web browser 102 (e.g., in Web browser settings, in a file operation request), other locations at computer system 101 (e.g., in system settings), and locations external to computer system 101 (e.g., from a distributed directory service, such as, in Active Directory (“AD”), Universal Description, Discovery and Integration (“UDDI”), etc.).

Accordingly, various different types of file security policies can interoperate with various different types of file access information to make a file access decision, when a module inside a security boundary requests access to a file outside the security boundary. FIG. 1B illustrates some of the types of policies and information that can be used to make a file access decision.

Referring now to FIG. 1B, file security polices 124 can include a variety of different policies, such as, for example, computer-executable representing how to process and/or determine domain access rights 181, application type access rights 182, storage quotas 183, override rules 184, file type access rules 186, file location access rules 187, etc. External program calls 185 represent extensibility hooks to extend file security policies 124 and/or access additional decision logic. Override rules 184 can include user-entered file security polices that override other general file security polices, for example, to implement exceptions to other file security polices. A series of three periods (a vertical ellipsis) represents that other file security policies, in addition to those expressly listed, may also be accessible to file access abstraction layer 103.

In some embodiments, file access abstraction layer 103 may require additional security policy information to make a file access decision for a file operation request. In these embodiments, Web browser 102 can present user-interface controls to a user prompting the user to enter additional file security policy information. Alternately, a user can expressly invoke user-interface controls to set file security polices for specified files, such as, for example, indicating file operations that are to be permitted and/or denied. User-entered file security polices can be appropriately maintained in any of the depicted types of file security polices 124 and/or maintained within a separate user-entered rules.

When appropriate, an administrator (e.g., of network 151) can adjust the behavior of file security polices (e.g., for a plurality of network computers) by changing configurable aspects of extensible security policy. For example, an administrator can adjust specific definitions of trust levels for files base don file location. Thus, when a sandboxed application is running on a Web page loaded from the Internet, the administrator can specify that only file data in the current users “My Documents” folder is accessible to the sandboxed application. On the other hand, when a sandboxed application is running on a Web page loaded from the local file system (e.g., of computer system 101), file data from any local files can be accessible to the sandboxed application.

Turning now to file access information, for a specified file operation request, some file access information, hereinafter referred to as “file operation properties”, can be obtained from the file operation request. Other file access information, hereinafter referred to as “ambient properties”, can be obtained from locations other than the file operation request. Ambient properties can be properties, such as, for example, Web browser properties, computer system properties, network properties, etc., that remain constant across a number of file operation requests and/or that require express user interaction to alter. Ambient settings can be altered though appropriate user-interface controls of computer system 101 and Web browser 102.

Accordingly, file access information 123 can include ambient properties 121 and file operation properties 122. Ambient properties 121 can include a variety of different types of information, such as, for example, URL information 161 (e.g. about the currently executing page and the host environment), trust zone information 162 (e.g., of the current page and the requested file resource), system settings 163, browser settings 164, other properties 165, etc. The vertical ellipsis represents that other ambient properties, in addition to those expressly listed, may also be accessible to file access abstraction layer 103.

File operation properties 122 includes essentially any information that can be contained in a file operation request, such as, for example, file access type 171 (e.g., read, write, file discovery, metadata inspection, etc.), request size 173, file path 172 (e.g., a file path for the requested file), etc. The vertical ellipsis represents that other file operation properties, in addition to those expressly listed, may also be accessible to file access abstraction layer 103.

File access abstraction layer 103 can utilize file access information 123 as input to file security polices 124 to make a file access decision (e.g., file access decision 191) for a file operation request (e.g., file operation request 194). A file access decision can include a decision to permit a file operation request as requested, to permit a file operation request with reduced rights (e.g., grant read access in response to a read/write request), or to deny a file operation request. File access abstraction layer 103 can notify a module (e.g., application 114C) of file access decisions corresponding to the module's file operation requests.

Referring briefly back to FIG. 1A, when file access is to be permitted, file access abstract layer 103 can access (or create) the requested file through a related request to the external storage location (e.g., file operation request 126 to storage 107). From the file (e.g., file 131), file access abstraction layer 103 can create a file stream (e.g., file stream 133) that includes portions of the file relevant to the file operation request (from the module within the security boundary). However, other portions of the file may not be included in the file stream. Accordingly, file access abstraction layer 103 can provide a sandboxed application with regulated access to external files in a manner that does not divulge security or other sensitive information about the file. For example, file access abstraction layer 103 can generate a file stream that includes the contents of a file but does not include corresponding file metadata (e.g., file path, volume information, etc.)

Embodiments of the invention have been described with respect to Web browser 102 being a host environment and hosting an application within a security boundary. However, it would be apparent to one skilled in the art, after having read this description, that other hosting environments, in addition to those expressly described, can also host networked or distributed applications within a security boundary. These other hosting environments can include modules similar to file access abstraction layer 103.

In accordance with the principles of the present invention, a file access abstraction layer within these other hosting environments can utilize file security policies and file access information to regulate inbound and outbound file based communication to and from applications within a security boundary. To facilitate regulation of file based communication in other hosting environments, a file access abstraction layer can make file access decisions when a module, for example, script or other executable code, within a security boundary attempts to communicate with a storage location outside the security boundary or vice versa.

Accordingly, in these other hosting environments, a file access abstraction layer can modify outbound communication sent from an application within a security boundary to a storage location outside of the security boundary. For example, these other hosting environments can determine if file operation requests originating within a security boundary are to be permitted. When a file operation request is permitted, these other hosting environments can also adjust the request file access in a secure manner (e.g., adjusting requested read/write access to read-only access). Likewise, in these other hosting environments, a file access abstraction layer can modify inbound communication sent from a storage location outside of the security boundary to a module within the security boundary. For example, a file access abstraction layer can create a file stream including less than all of the contents for a file.

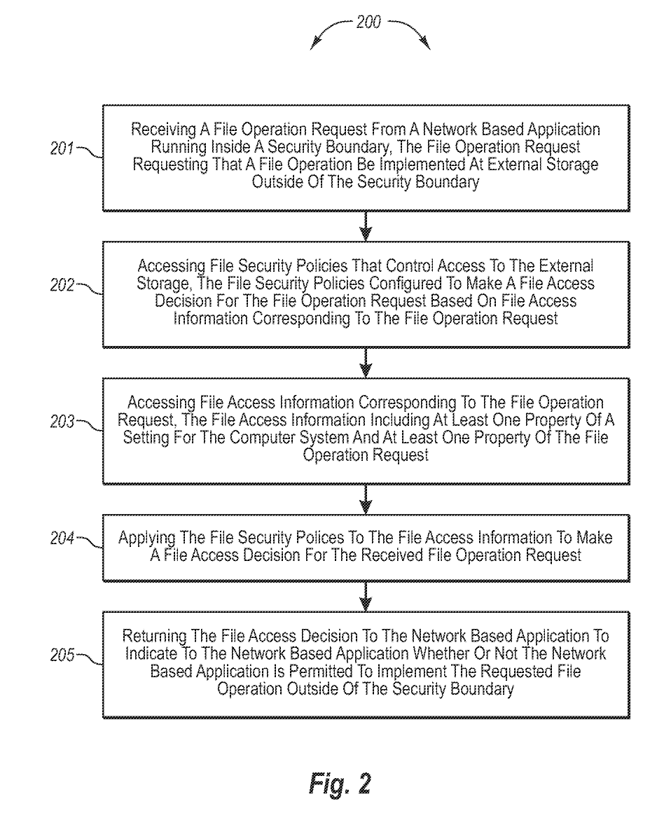

FIG. 2 illustrates a flow chart of an example method for making a file access decision for a module inside a security boundary. The method 200 will be described with respect to the components and data of computer architecture 100 depicted in FIGS. 1A and 1B.

Method 200 includes an act of receiving a file operation request from a network based application running inside a security boundary, the file operation request requesting that a file operation be implemented at external storage outside of the security boundary (act 201). For example, file access abstraction layer 103 can receive file operation request 194 from application 114C running within sandbox 106. File operation request 194 can request that a file operation be implemented at storage 107 (outside of sandbox 106). For example, application 114C can request to read data from and/or write data to file 131.

Method 200 includes an act of accessing file security policies that control access to the external storage, the file security policies configured to make a file access decision for the file operation request based on file access information corresponding to the file operation request (act 202). For example, file access abstraction layer 103 can access file security policies 124. File security policies 124 can be configured to make a file access decision for file operation request 194 based on corresponding file access information. The originating points of the arrow passing through file security policies 124 indicates that different portions of file security policies 124 can be accessed from different locations, such as, for example, within Web browser 102, else where at computer system 101, and/or from locations external to computer system 101.

Method 200 includes an act of accessing file access information associated with the file operation request, the file access information including at least one property of a setting for the computer system and at least one property of the file operation request (act 203). For example, file access abstraction layer 103 can access file access information 123. File access information 123 can include at least ambient properties 121 and file operation properties 122. The originating points of the arrow passing through file access information 123 indicates that different portions of file access information 123 can be accessed from different locations, such as, for example, within Web browser 102, else where at computer system 101, and/or from locations external to computer system 101.

Method 200 includes an act of applying the file security polices to the file access information to make a file access decision for the received file operation request (act 204). For example (now referring specifically to FIG. 1B), file access abstraction layer 103 can apply file security policies 124 to file access information 123 to make a file access decision 191 (for file operation request 194). When file security policies 124 include computer-executable instructions, file access abstraction layer 103 can provide appropriate portions of file access information 123 as input to the computer-executable instructions. File access abstraction layer 103 can apply appropriate logic (e.g., aggregating results, giving preference to override and/or user-entered rules, etc) for making a file access decision based on results from different types of file security policies.

Method 200 includes an act of returning the file access decision to the network based application to indicate to the network based application whether or not the network based application is permitted to implement the requested file operation outside of the security boundary (act 205). For example, file access abstraction layer 103 can return file access decision 191 to application 114C to indicate to application 114C whether or not a requested file operation is to be permitted at storage 107.

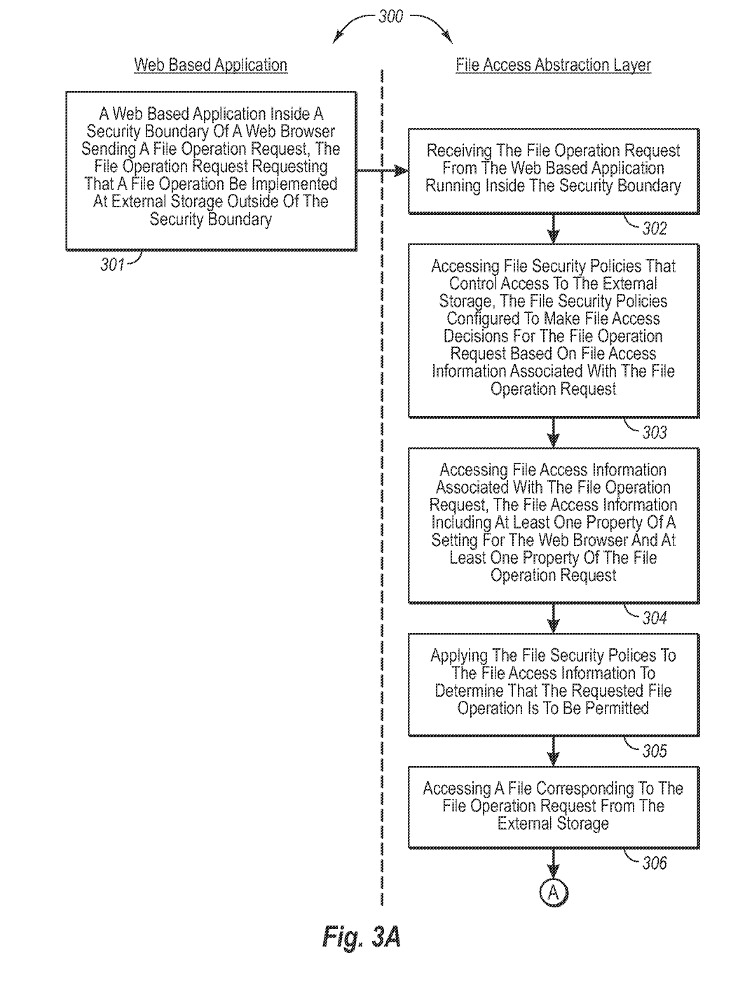

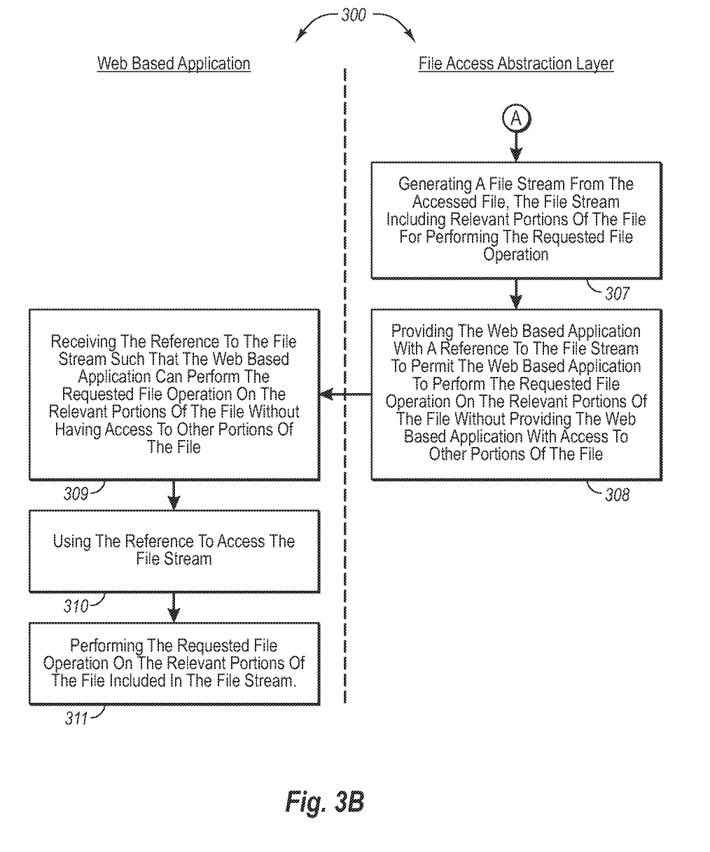

When a requested file operation is to be permitted (whether as originally requested or with reduced rights), file access abstraction layer 103 can provide a requesting application (inside a security boundary) with appropriate file data in a manner that does not divulge security information about a file (outside the security boundary). FIGS. 3A and 3B illustrate a flow chart of an example method 300 for permitting a module inside a security boundary to access a file outside the security boundary. The method 300 will be described with respect to the components and data of computer architecture 100 depicted in FIGS. 1A and 1B.

Method 300 is described with respect to an application within a Web browser host environment communicating with a storage location outside a security boundary. However, method 300 is not limited to the described environment. It should be understood that method 300 is equally applicable to other hosting environments where an application requests content and/or receives content other than Web based content.

Method 300 includes an act of a Web based application inside a security boundary sending a file operation request, the file operation request requesting that a file operation be implemented at the external storage outside of the security boundary (act 301). For example, application 114C, running within sandbox 106, can send file operation request 194. File operation request 194 can request that a file operation be implemented at storage 107 (i.e., outside of sandbox 106). For example, application 114C can request to read data from and/or write data to file 131.

Method 300 includes an act of receiving the file operation request from the Web based application running inside the security boundary (act 302). For example, file access abstraction layer 103 can receive file operation request 194 from application 114C running within sandbox 106.

Method 300 includes an act of accessing file security policies that control access to the external storage, the file security policies configured to make a file access decision for the file operation request based on file access information associated with the file operation request (act 303). For example, file access abstraction layer 103 can access file security policies 124. File security policies 124 can be configured to make a file access decision for file operation request 194 based on corresponding file access information. Method 300 includes an act of accessing file access information associated with the file operation request, the file access information including at least one property of a setting for the Web browser and at least one property of the file operation request (act 304). For example, file access abstraction layer 103 can access file access information 123. File access information 123 can include at least ambient properties 121 and file operation properties 122.

Method 300 includes an act of applying the file security polices to the file access information to determine that the requested file operation is to be permitted (act 305). For example, file access abstraction layer 103 can apply file security policies 124 to file access information 123 to determine that a file operation indicated in file operation request 194 is to be permitted. File access abstraction layer 103 can apply appropriate logic (e.g., aggregating results, giving preference to override and/or user-entered rules, etc) to determine that the file operation indicated in file operation request 194 is to be permitted.

Method 300 includes an act accessing a file corresponding to the file operation request from the external storage (act 306). For example, file access abstraction layer 103 can formulate file operation request 126 to request file 131 from storage 107. File operation request 126 can be similar to file operation request 194 However, file operation request 126 can differ from file operation request 194 at least in that storage 107 is requested to send file 107 back to file access abstraction layer 103 (as opposed to application 114C). File operation request 126 can also differ from file operation request 194 in other ways. For example, to create a stream of file data from file 131, file access abstraction layer 103 may need increased levels of access over those requested in file operation request 194.

In response to receiving file operation request 126, storage 107 can return a file handle to file 131. File access abstraction layer 103 can receive the file handle and use the file handle to access file 131.

Method 300 includes an act of generating a file stream from the accessed file, the file stream including relevant portions of the file for performing the requested file operation (act 307). For example, file access abstraction layer 103 can generate file stream 133 from file 131. File stream 131 can be generated such that only the portions of file 131 that are needed to perform a file operation indicated in file operation request 194. For example, if application 114C has requested to read the contents of file 131, security related metadata and location data for file 131 are not included in file stream 133.

File access abstraction layer 103 can also generate stream reference 132 for accessing file stream 133. The below listed code depicts an example of a safe and opaque file handle as well as display a portion of user-interface. A user can interact with the portion of user-interface to indicate that data in the file stream can be manipulated using the file handle.

```
private void OnOpenButtonClick (object sender, EvenArgs e) {
  using (Stream fileStream = SafeFileDialog.OpenFile (“Open XAML
                                  File” “XAML Files”, “*.xaml”,
                                  /* addAllFilesFilter*/ true )){
    if (filestream != null) {
      SafeStreamReader reader = new SafeStreamReader (fileStream);
        String xamlMarkup = reader.ReadToEnd( );
        //further instructions for processing the xamlMarkup
    }
  }
}
```

Method 300 includes an act of sending the Web based application a reference to the file stream to permit the Web based application to perform the requested file operation on the relevant portions of the file without providing the Web based application with access to other portions of the file (act 308). For example, file access abstraction layer 103 can send stream reference 132 to application 114C. Stream reference 132 permits application 114C to perform a file operation on data in file stream 133 (i.e., the contents of file 131) with providing application 114C with access to other portions of file 131 (e.g., path and security information).

Method 300 includes an act of receiving the reference to a file stream such that the Web based application can perform the requested file operation on the relevant portions of the file without having access to other portions of the file (act 309). For example, application 114C can receive stream reference 132. Method 300 includes an act of using the reference to access the file stream (act 310). For example, application 114C can use stream reference 132 to access file stream 133. However, stream reference 132 does not permit application 114C to access other portions of file 131. Method 300 includes an act of performing the requested file operation on the relevant portions of the file included in the file stream (act 311). For example, application 114C can perform a file operation, such as, for example, create, read, write, delete, enumerate files, read metadata associated with a file, etc., on portions of file 131 included in file stream 133.

When the file operation is completed, application 114C can indicate that file stream 133 is to be closed. File access abstraction layer 103 can receive the close command. In response to the close command, file access abstraction layer 103 can propagate the file operation performed on file stream 133 into file 131. File access abstraction layer 103 can then issue a second close command to storage 107. Storage 107 can receive the second close commands and close file 131.

Accordingly, embodiments of the present invention can provide modules within a security boundary access to files outside the security boundary in a secure manner. When a module inside a security boundary is permitted to access a file, only those portions of the file needed to perform a corresponding file operation are made accessible to the module. File access decisions can be made based on ambient data already accessible to a host environment such that file access decisions can be made in a more automated manner.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system including a host environment, a network based application running inside a security boundary of the host environment, and one or more files stored in external storage outside of the security boundary, a method for making a file access decision for the network based application, the method comprising:
an act of receiving a file operation request from the network based application running inside the security boundary, the file operation request requesting that a file operation be implemented at the external storage outside of the security boundary;
an act of accessing file security policies that control access to the external storage, the file security policies configured to make a file access decision for the file operation request based on file access information corresponding to the file operation request;
an act of accessing file access information associated with the file operation request, the file access information including at least one property of a setting for the computer system and at least one property of the file operation request;
an act of applying the file security polices to the file access information to make a file access decision for the received file operation request; and
an act of returning the file access decision to the network based application to indicate to the network based application whether or not the network based application is permitted to implement the requested file operation outside of the security boundary.

2. The method as recited in claim 1, wherein an act of receiving a file operation request from the network based application running inside the security boundary comprises an act of receiving a file operation request from a client-side script running inside a sandbox.

3. The method as recited in claim 1, wherein the act of receiving a file operation request from the network based application running inside the security boundary comprises an act of receiving a file operation request to perform one of the following: create a file, read from a file, write to a file, delete a file, enumerate files, and read metadata associated with a file.

4. The method as recited in claim 1, wherein the act of accessing file security policies that control access to the external storage comprises an act of accessing file security policies including one or more of domain access rights, application type access rights, storage quota, override rules, external program calls, file type access rules, and file location access rules.

5. The method as recited in claim 1, wherein the act of accessing file access information associated with the file operation request comprises an act of accessing ambient information associated with the host environment.

6. The method as recited in claim 1, wherein the act of accessing file access information associated with the file operation request comprises an act of accessing file access information including one or more of URL information, trust zone information, system settings, browser settings, file access type, file path, and request size.

7. The method as recited in claim 1, wherein the act of applying the file security polices to the file access information to make a file access decision for the received file operation request comprises an act of providing the file access information as input to computer-executable instructions included in the file security polices.

8. At a computer system including a Web browser, a Web based application running inside a security boundary of the Web browser, and one or more files stored in external storage outside of the security boundary, a method for implementing a file operation originating from the Web based application inside the security boundary at the external storage outside of the security boundary, the method comprising:
an act of receiving a file operation request from the Web based application running inside the security boundary, the file operation request requesting that a file operation be implemented at the external storage outside of the security boundary;
an act of accessing file security policies that control access to the external storage, the file security policies configured to make a file access decision for the file operation request based on file access information associated with the file operation request;
an act of accessing file access information associated with the file operation request, the file access information including at least one property of a setting for the Web browser and at least one property of the file operation request;
an act of applying the file security polices to the file access information to determine that the requested file operation is to be permitted;
an act accessing a file corresponding to the file operation request from the external storage;
an act of generating a file stream from the accessed file, the file stream including relevant portions of the file for performing the requested file operation; and
an act of sending the Web based application a reference to the file stream to permit the Web based application to perform the requested file operation on the relevant portions of the file without providing the Web based application with access to other portions of the file.

9. The method as recited in claim 8, wherein the act of receiving a file operation request from the Web based application running inside the security boundary comprises an act of receiving a file operation request from a client-side script running in a sandbox.

10. The method as recited in claim 8, wherein the act of receiving a file operation request from the Web based application running inside the security boundary comprises an act of receiving a file operation request for the contents of a file to include in a Web page.

11. The method as recited in claim 8, wherein the act of accessing file security policies that control access to the external storage, comprises:
an act of presenting a user-interface control prompting a user to enter a file security policy related to the file operation request; and
an act of receiving user-input data through the user-interface control, the user-input data indicative of a file security policy related to the file operation request.

12. The method as recited in claim 8, wherein the act of accessing file access information associated with the file operation request comprises an act accessing a browser setting of the Web browser that persists across multiple file operation requests.

13. The method as recited in claim 8, wherein the act of generating a file stream from the accessed file comprises an act of excluding portions of the file that are not needed to implement a requested file operation from the file stream.

14. The method as recited in claim 8, wherein the act of sending the Web based application a reference to the file stream to permit the Web based application to perform the requested file operation comprises an act of sending the reference to the file stream to permit the Web based application to use relevant portions of the file to construct a Web page.

15. At a computer system including a Web browser, a file access abstraction layer, and a Web based application running inside a security boundary of the Web browser, and one or more files stored in external storage outside of the security boundary, a method for implementing a file operation originating from the Web based application inside the security boundary at the external storage outside of the security boundary, the method comprising:
an act of the Web based application inside the security boundary sending a file operation request, the file operation request requesting that a file operation be implemented at the external storage outside of the security boundary;
an act of receiving a reference to a file stream, the file stream including relevant portions of a file for performing the requested file operation so as to permit the Web based application to perform the requested file operation on the relevant portions of the file without providing the Web based application with access to other portions of the file.
an act of using the reference to access the file stream; and
an act of performing the requested file operation on the relevant portions of the file included in the file stream.

16. The method as recited in claim 15, further comprising:
an act of sending a Web page request to a Web server;
an act of receiving a Web page that includes the Web based application fro the Web server; and
an act of running the Web based application within the security boundary.

17. The method as recited in claim 16 wherein the act of the Web based application inside the security boundary sending a file operation request comprises an act of a client-side script running inside a sandbox sending a file operation request to access a file outside of the sandbox.

18. The method as recited in claim 16, wherein the act of receiving a reference to a file stream comprises an act of receiving a reference that provides access to the contents of a file without divulging security information related to the file.

19. The method as recited in claim 18, wherein the act of performing the requested file operation on the relevant portions of the file included in the file stream comprises an act of altering the contents of the file stream.

20. The method as recited in claim 18, wherein the act of performing the requested file operation on the relevant portions of the file included in the file stream comprises an act of including the contents of the file stream in a Web page.
